(19) United States
(12) Patent Application Publication
(10) Pub. No.: US 2015/0154764 A1
(43) Pub. Date: Jun. 4, 2015

(54) MEDICAL IMAGING APPARATUS, SYSTEM AND METHOD FOR DISPLAYING MEDICAL IMAGES

(71) Applicant: Siemens Aktiengesellschaft, Muenchen (DE)

(72) Inventors: Shu Qun Xie, Shenzhen (CN); Yong Chao Zhou, Shenzhen (CN)

(73) Assignee: SIEMENS AKTIENGESELLSCHAFT, Muenchen (DE)

(21) Appl. No.: 14/554,359

(22) Filed: Nov. 26, 2014

(30) Foreign Application Priority Data
Nov. 29, 2013 (CN) 201310628546.7

(51) Int. Cl. G06T 11/00; G06T 7/00; G06T 1/20; G06T 11/20

(52) U.S. Cl. CPC G06T 11/003; G06T 11/20; G06T 7/0012; G06T 1/20

(57) ABSTRACT

In a medical imaging apparatus, system and a method for displaying medical images, an image display unit and an image reconstruction unit are virtual machines running on a single physical computer. The image reconstruction unit receives medical imaging data and reconstructing a medical image based on the medical imaging data. The image display unit displays the medical image. Multiple physical computers in a medical imaging apparatus are thereby concentrated in a single physical computer with the use of virtualization technology, thereby enabling costs to be reduced significantly and the system to be simplified, increasing the system maintenance efficiency.

### BACKGROUND OF THE INVENTION

1. Field of the Invention

The present invention relates to the technical field of medical imaging, in particular to a medical imaging apparatus, system and method for displaying medical images.

2. Description of the Prior Art

Medical imaging is also known as medical image formation. Medical imaging is a general term for the process of using modern imaging techniques such as X-ray imaging, computed tomography scanning (CT), nuclear magnetic resonance imaging (MRI), ultrasound imaging, positron emission tomography scanning (PET), electroencephalograms (EEG), magnetoencephalograms (MEG), eye-tracking and transcranial magnetic stimulation (TMS) to examine parts of the human body which cannot be examined by non-surgical means.

At present, many medical imaging apparatuses include a number of physical computers connected to each other by Ethernet. These computers are an important constituent part of the medical imaging apparatus, being able to: provide a user interface for acquiring user input parameters and user instructions; convert an examination protocol to corresponding control signals and transmit these control signals to relevant elements; provide an overall communication interface for the medical imaging apparatus; receive original data and perform image reconstruction; and be used to display images and perform image post-processing operations.

Currently, medical imaging apparatuses that include multiple physical computers are expensive, and make the overall structure of the system complicated and difficult to maintain. Furthermore, certain operating systems used in medical apparatus are quite old, so it is difficult to find appropriate compatible computers.

### SUMMARY OF THE INVENTION

An object of the present invention is to provide a medical imaging apparatus, a medical imaging system and a method for displaying medical images, wherein the maintainability thereof over time is improved.

A medical imaging apparatus in accordance with the invention has an image display unit and an image reconstruction unit, wherein the image display unit and image reconstruction unit are virtual machines running on a single physical computer. The image reconstruction unit is designed to receive medical imaging data, and to reconstruct a medical image based on the medical imaging data. The image display unit displays the medical image.

The apparatus can further include an image post-processing unit, which is a virtual machine running on the single physical computer. The image post-processing unit is designed to acquire a medical image from the image reconstruction unit, and to subject the medical image to image post-processing.

The apparatus can additionally include, or include instead of the image post-processing unit, a scan control unit, which is a virtual machine running on the single physical computer. The image reconstruction unit receives the medical imaging data from a medical image acquisition apparatus and the scan control unit controls the medical image acquisition apparatus to acquire the medical imaging data.

The image display unit accesses a graphics card on the single physical computer by pass-through; and/or the image reconstruction unit accesses a receiving card on the single physical computer by pass-through; and/or the image post-processing unit accesses a graphics card on the single physical computer by pass-through; and/or the scan control unit accesses a control card on the single physical computer by pass-through.

A medical imaging system includes a medical image acquisition apparatus and a medical imaging apparatus as described above, the medical image acquisition apparatus being designed for acquiring medical image data. The medical imaging apparatus receives medical imaging data from the medical image acquisition apparatus.

The medical image acquisition apparatus is an MRI acquisition apparatus, a CT scanning apparatus, an X-ray imaging acquisition apparatus, an ultrasound imaging acquisition apparatus, a PET scanning apparatus, an EEG acquisition apparatus, an MEG acquisition apparatus, an eye-tracking acquisition apparatus or a TMS acquisition apparatus.

A method for displaying medical imaging, includes the steps of allocating a first calculation resource and a second calculation resource on a single physical computer, forming a first virtual machine by virtualization based on the first calculation resource, and forming a second virtual machine by virtualization based on the second calculation resource, enabling the first virtual machine to receive medical imaging data, and reconstructing a medical image based on the medical imaging data, and enabling the second virtual machine to display the medical image.

Further, a third calculation resource can be allocated on the single physical computer, and a third virtual machine is formed by virtualization based on the third calculation resource; the third virtual machine is enabled to acquire a medical image from the first virtual machine, and subject the medical image to image post-processing.

Alternatively or in addition, the first virtual machine receives medical imaging data from a medical image acquisition apparatus, and a fourth calculation resource is allocated on the single physical computer. A fourth virtual machine is formed by virtualization based on the fourth calculation resource, and the fourth virtual machine is enabled to control the medical image acquisition apparatus to acquire medical imaging data.

The first virtual machine accesses a receiving card on the single physical computer by pass-through; and/or the second virtual machine accesses a graphics card on the single physical computer by pass-through; and/or the third virtual machine accesses a graphics card on the single physical computer by pass-through; and/or the fourth virtual machine accesses a control card on the single physical computer by pass-through.

It can be seen from the technical solution above that the medical imaging of the present invention includes an image display unit and an image reconstruction unit, wherein the image display unit and image reconstruction unit are virtual machines running on a single physical computer; the image reconstruction unit is for receiving medical imaging data, and reconstructing a medical image based on the medical imaging data; the image display unit is for displaying the medical image. As can be seen, when the present invention is adopted, multiple physical computers in a medical imaging apparatus are concentrated in a single physical computer with the aid of virtualization technology, thereby enabling costs to be reduced significantly and the system to be simplified, increasing the system maintenance efficiency.

Furthermore, in the embodiments of the present invention, the virtual machines need not be associated with specific hardware, so that the issue of compatibility in medical apparatus, arising from the fact that certain operating systems are quite old, is also overcome.

### BRIEF DESCRIPTION OF THE DRAWINGS

FIG. 1 is a block diagram of the medical imaging apparatus of the present invention.

FIG. 2 is a block diagram of the medical imaging system of the present invention.

FIG. 3 is a block diagram of a medical imaging apparatus system according to a first embodiment of the present invention.

FIG. 4 is a flowchart of the method for displaying medical imaging of the present invention.

### DESCRIPTION OF THE PREFERRED EMBODIMENTS

The present invention is explained in further detail below with reference to embodiments and the accompanying drawings, in order to clarify the technical solution and merits thereof. It should be understood that the particular embodiments described here are intended merely to explain the present invention elaborately, not to define the scope of protection thereof.

In recent years, as the performance of computer hardware such as central processing units (CPU), memory and hard disks has steadily improved, virtualization technology has become popular. The main objective of virtualization is to disengage software running in a virtual machine from physical hardware. Virtualization technology can integrate multiple computers having different functions in one server, so as to save unnecessary hardware, and increase the hardware usage efficiency.

In the embodiments of the present invention, multiple physical computers in a medical imaging apparatus are concentrated in a single physical computer (Host) with the aid of virtualization technology; specifically, the functions of the various physical computers can be virtualized to form a virtual machine having corresponding functions in a single physical computer. By “virtual machine” is meant a complete computer system which is simulated by software, has complete hardware system functionality, and runs in an isolated environment.

Examples of virtual machine software in common use at present are VMware (VMware ACE), Virtual Box and Virtual PC, etc. These can all create multiple virtual machines by virtualization on many kinds of operating system, such as Windows. From the viewpoint of a user, a virtual machine can be an application running on a physical computer, but from the viewpoint of an application running in a virtual machine, the virtual machine can be regarded as a real computer. The virtual machine environment can be managed by a virtual machine manager such as Hypervisor.

Each virtual machine can use a different operating system; the operating system running on a virtual machine is generally referred to as Guest OS. For example: if VMware virtualization software is installed on a physical computer on which the Windows NT operating system is installed, then the Host is the physical computer on which Windows NT is installed, the operating system thereof being Windows NT; if the operating system running on VMware is Linux, then Linux is the Guest OS. Files, applications and network resources, etc. can be shared between virtual machines.

FIG. 1 is a block diagram of the medical imaging apparatus of the present invention.

As FIG. 1 shows, the medical imaging apparatus includes an image display unit 101 and an image reconstruction unit 102, wherein the image display unit 101 and image reconstruction unit 102 are virtual machines running on a single physical computer.

The image reconstruction unit 101 is for receiving medical imaging data, and reconstructing a medical image based on the medical imaging data.

The image display unit 102 is for displaying the medical image.

Specifically, the image reconstruction unit 101 can receive medical imaging data from various medical imaging data sources, and reconstruct a medical image based on the medical imaging data. The image reconstruction unit 101 preferably accesses a receiving card on the single physical computer by pass-through, so as to use the receiving card to receive medical imaging data from various medical imaging data sources. Medical imaging data sources generally provide discrete image data; the image reconstruction unit 101 can subject the discrete image data to linear spatial interpolation or linear spatial filtering etc., in order to reacquire a continuous image. This process is referred to as image reconstruction.

Specifically, pass-through can be achieved by means of Intel's virtualization technology for Direct I/O or AMD's input/output memory management unit (IOMMU). Pass-through can allow a client to have exclusive access to an I/O device in certain tasks, e.g. to a device having a PCI/PCIe, USB or SATA interface. Pass-through technology results in the I/O device appearing as if it was physically attached to the client operating system. When pass-through is employed, a device attached to the virtual machine has performance approaching that of a physical device.

There is a virtual Ethernet connection between the image reconstruction unit 101 and the image display unit 102. The image display unit 102 acquires a medical image via the virtual Ethernet connection. Moreover, the image display unit 102 may access a graphics card on the single physical computer by pass-through. Based on the support of the graphics card and a display device, the image display unit 102 can display the medical image to a user.

Preferably, other functions related to medical image formation and processing can be integrated on the image display unit 102; for example, the image display unit 102 may also provide a man-machine interaction interface for the user, to acquire input control parameters and instructions from the operator. The image display unit 102 may also manage patient information, for example increase, delete or alter a patient's personal information and historical scan record information. The image display unit 102 may also have image processing functions such as image browsing, image calculation and image assessment. The image display unit 102 may also have functions such as imaging sequence programming.

In one embodiment, the medical imaging apparatus further includes an image post-processing unit 103 which is similarly a virtual machine running on the single physical computer.

There is a virtual Ethernet connection between the image reconstruction unit 101 and the image post-processing unit 103. The image post-processing unit 103 acquires a medical image via the virtual Ethernet connection.

The image post-processing unit 103 is for acquiring a medical image from the image reconstruction unit 101, and subjecting the medical image to image post-processing. Preferably, the image post-processing unit 103 accesses a graphics card on the single physical computer by pass-through, and subjects the medical image to image post-processing based on the support of the graphics card.

Specifically, image post-processing includes at least one of the following types of processing: 3D image generation; piecing together of image features; generation of statistical reports based on the medical image; medical image browsing; medical image measurement; medical image printing; medical function parameter calculation, etc.

As GPU virtualization technology gradually matures, the performance of virtual graphics cards will meet the demands of medical image display and processing. Thus the image reconstruction unit 101 and the image post-processing unit 103 may also use a virtual video card directly to perform corresponding operations, rather than accessing a graphics card on the single physical computer by pass-through.

Specific examples of image post-processing have been listed in detail above, but those skilled in the art will realize that such a list is merely exemplary, and not intended to define the scope of protection of the embodiments of the present invention.

In another embodiment, the medical imaging apparatus further includes a scan control unit 104 which is a virtual machine running on the single physical computer.

The image reconstruction unit 102 is for receiving the medical imaging data from a medical image acquisition apparatus (not shown in the figures); the scan control unit 104 is for controlling the medical image acquisition apparatus to acquire the medical imaging data.

Preferably, the scan control unit 104 accesses a control card on the single physical computer by pass-through, and based on the support of the control card, controls the medical image acquisition apparatus to acquire medical imaging data. For example, the scan control unit 104 can send control and acquisition commands containing acquisition parameters to the medical image acquisition apparatus; the acquisition parameters may include the specific acquisition time, the acquired signal type, the acquisition position, etc.

A graphical interface provided by the image display unit 101 may be used to obtain acquisition commands from the user; the scan control unit 104 may obtain acquisition commands from the image display unit 102, and use the acquisition commands to control the medical image acquisition apparatus to acquire medical imaging data.

The image reconstruction unit 101, image display unit 102, image post-processing unit 103 and scan control unit 104 may be interconnected by a virtual Ethernet bus. The physical computer containing the image reconstruction unit 101, image display unit 102, image post-processing unit 103 and scan control unit 104 may use a VM Hypervisor operating system (e.g. VMware ESXI, Wind River Hypervisor, etc.), a Linux operating system, or a Windows Server operating system having some kind of virtualization software (e.g. KVM, parallel workstation, etc.). The physical computer allocates suitable calculation resources (including CPU, memory, hard disk, network adapter, etc.) to the image reconstruction unit 101, image display unit 102, image post-processing unit 103 and scan control unit 104 separately. Moreover, data can be transmitted among the image reconstruction unit 101, image display unit 102, image post-processing unit 103 and scan control unit 104 by means of the virtual Ethernet bus. Furthermore, the virtualization work used in the physical computer supports I/O pass-through technology, and PCI/PCIe devices such as digital control cards, digital receiving cards and graphics cards are attached to the corresponding virtual machines, so that real-time performance of medical imaging can be guaranteed and 3D images can be produced.

Based on the detailed analysis above, the present invention also presents a medical imaging system.

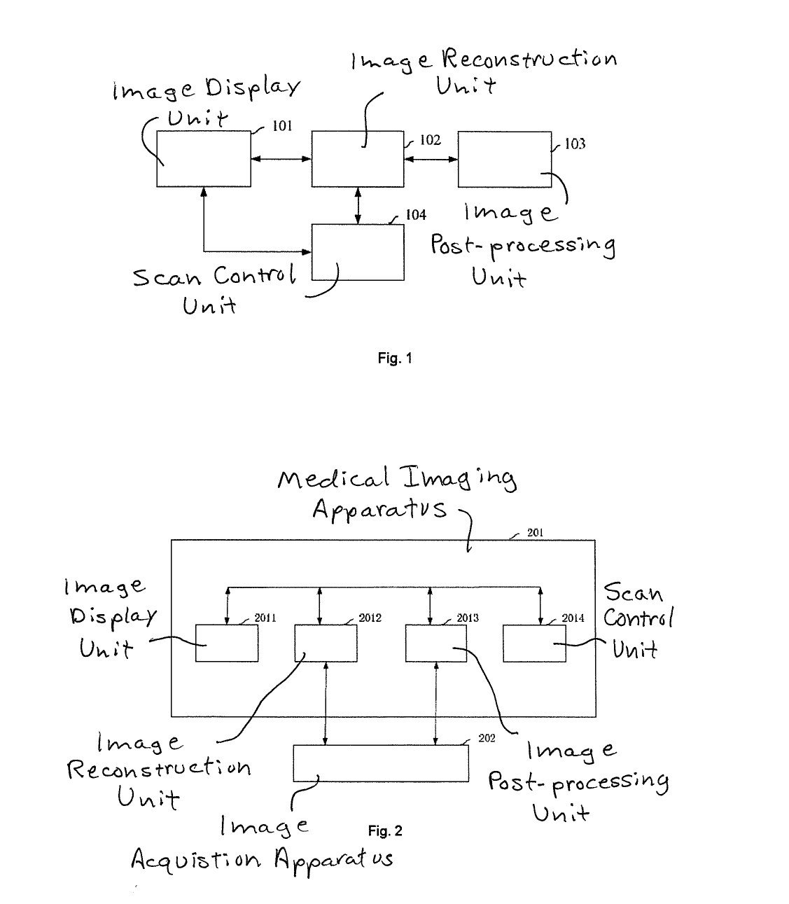

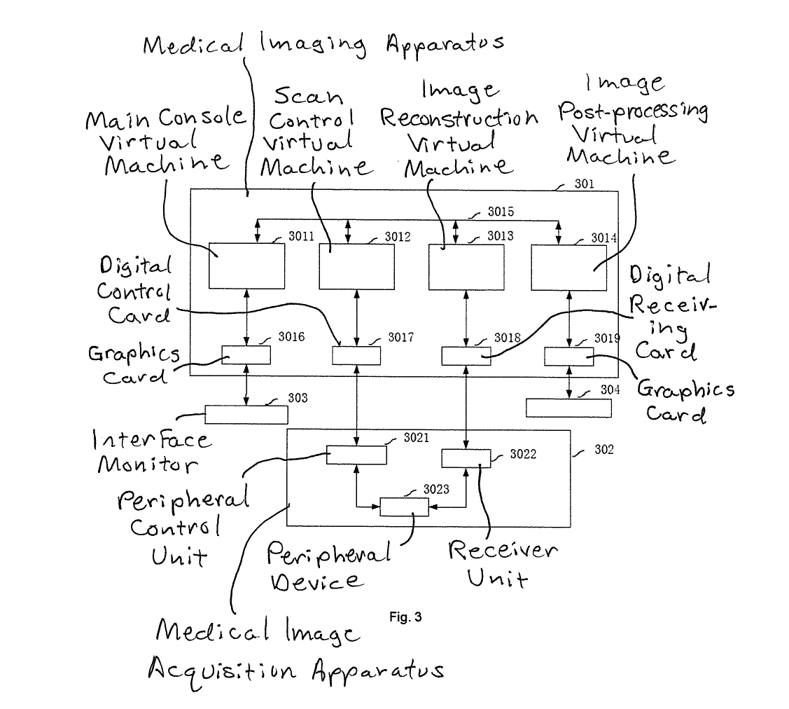

FIG. 2 is a block diagram of the medical imaging system of the present invention.

As FIG. 2 shows, the system includes a medical imaging apparatus 201 and a medical image acquisition apparatus 202.

The medical image acquisition apparatus 202 is for acquiring medical image data.

The medical imaging apparatus 201 is for receiving medical imaging data from the medical image acquisition apparatus.

The medical imaging apparatus 201 may comprise an image display unit 2011 and an image reconstruction unit 2012, wherein the image display unit 2011 and image reconstruction unit 2012 are virtual machines running on a single physical computer. The image reconstruction unit 2011 receives medical imaging data, and reconstructs a medical image based on the medical imaging data; the image display unit 2012 displays the medical image.

The medical imaging apparatus 201 may further comprise an image post-processing unit 2013 and a scan control unit 2014; the image post-processing unit 2013 and scan control unit 2014 are similarly virtual machines running on the single physical computer. The image reconstruction unit 2012 receives medical imaging data from the medical image acquisition apparatus 202; the scan control unit 2014 controls the medical image acquisition apparatus 202 to acquire the medical imaging data.

The image display unit 2011, image reconstruction unit 2012, image post-processing unit 2013 and scan control unit 2014 communicate with each other by the same virtual Ethernet bus.

Preferably, the medical image acquisition apparatus 201 may specifically be an MRI acquisition apparatus, a CT scanning apparatus, an X-ray imaging acquisition apparatus, an ultrasound imaging acquisition apparatus, a PET scanning apparatus, an EEG acquisition apparatus, an MEG acquisition apparatus, an eye-tracking acquisition apparatus or a TMS acquisition apparatus, etc.

Specific examples of medical image acquisition apparatuses have been listed in detail above, but those skilled in the art will realize that such a list is merely exemplary, and not intended to define the scope of protection of the embodiments of the present invention.

FIG. 3 is a block diagram of a medical imaging apparatus system according to a first embodiment of the present invention. In this embodiment, the medical image acquisition apparatus acquires medical image data by magnetic resonance.

As FIG. 3 shows, the system includes a medical imaging apparatus 301 and a medical image acquisition apparatus 302.

The medical imaging apparatus 301 may specifically be a physical server; running on the server are a main console virtual machine 3011, a scan control virtual machine 3012, an image reconstruction virtual machine 3013 and an image post-processing virtual machine 3014. The server may use a VM Hypervisor operating system (e.g. VMware ESXI, Wind River Hypervisor, etc.), a Linux operating system, or a Windows Server operating system having some kind of virtualization software (e.g. KVM, parallel workstation, etc.). Moreover, data can be transmitted among the main console virtual machine 3011, scan control virtual machine 3012, image reconstruction virtual machine 3013 and image post-processing virtual machine 3014 by means of a virtual Ethernet bus 3015.

The image reconstruction virtual machine 3013 may access a digital receiving card 3018 of the server by pass-through, use the digital receiving card 3018 to receive medical imaging data from the medical image acquisition apparatus 302, and reconstruct a medical image based on the medical imaging data.

The main console virtual machine 3011 acquires the reconstructed medical image from the image reconstruction virtual machine 3013, accesses a graphics card 3016 of the server by pass-through, and cooperates with a connected user interface monitor 303, so as to display the medical image.

The main console virtual machine 3011 may further provide an input interface for the user, with which the user enters scan parameters on the user interface, and the scan parameters being sent to the scan control virtual machine 3012. On the basis of the scan parameters, the scan control virtual machine 3012 then controls the medical image acquisition apparatus 302 to acquire medical imaging data. The scan control virtual machine 3012 may access a digital control card 3017 on the server by pass-through.

The image post-processing virtual machine 3014 acquires a reconstructed medical image from the image reconstruction virtual machine 3013, and subjects the reconstructed medical image to image post-processing. The image post-processing virtual machine 3014 may access a graphics card 3019 on the server by pass-through.

The medical image acquisition apparatus 302 may include a peripheral control unit 3021, a receiver unit 3022 and a peripheral device 3023. The peripheral control unit 3023 receives scan parameters from the scan control virtual machine 3012 of the medical imaging apparatus 301, and sends an excitation signal to the peripheral device 3023 based on the scan parameters. The peripheral device 3023 controls a transmitting coil to emit an RF signal, which acts on the human body and to cause magnetic resonance signals to occur due to the magnetic resonance effect. The receiver unit 3022 receives the magnetic resonance signal, and performs necessary operations thereon before sending it to the image reconstruction virtual machine 3013 of the medical imaging apparatus 301.

Based on the detailed analysis above, the embodiments of the present invention also present a method for displaying medical imaging.

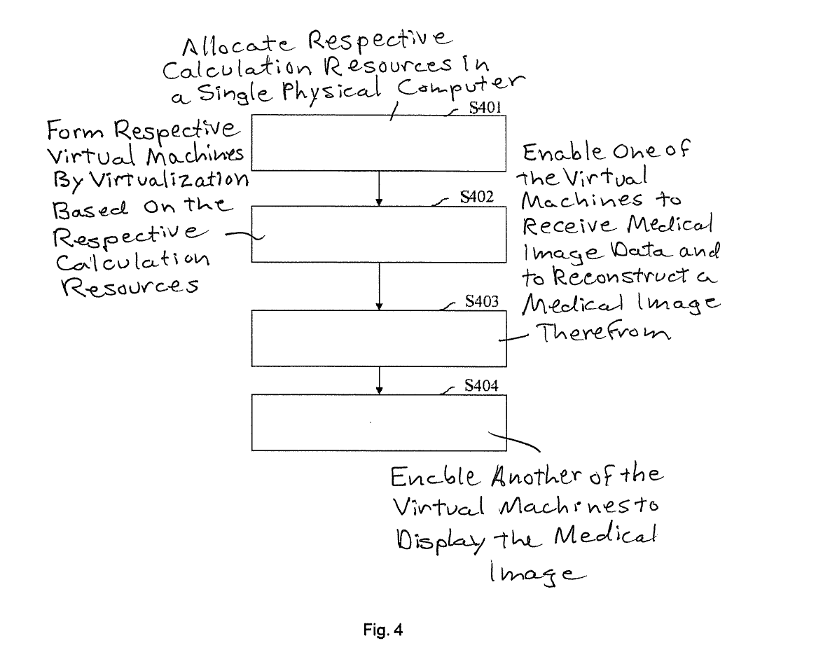

FIG. 4 is a flow chart of the method for displaying medical imaging of the present invention.

As FIG. 4 shows, the method proceeds as follows.
step S401: allocating a first calculation resource and a second calculation resource on a single physical computer;
step S402: forming a first virtual machine by virtualization based on the first calculation resource, and forming a second virtual machine by virtualization based on the second calculation resource;
step S403: enabling the first virtual machine to receive medical imaging data, and reconstructing a medical image based on the medical imaging data;
step 5404: enabling the second virtual machine to display the medical image.

In an embodiment, the method further includes:

allocating a third calculation resource on the single physical computer;

forming a third virtual machine by virtualization based on the third calculation resource;

enabling the third virtual machine to acquire a medical image from the first virtual machine, and subject the medical image to image post-processing, the image post-processing comprising at least one of the following types of processing: 3D image generation; piecing together of image features; generation of statistical reports based on the medical image; medical image browsing; medical image measurement; medical image printing; medical function parameter calculation, etc.

In an embodiment, the first virtual machine receives medical imaging data from a medical image acquisition apparatus; the method further comprises: allocating a fourth calculation resource on the single physical computer, forming a fourth virtual machine by virtualization based on the fourth calculation resource, enabling the fourth virtual machine to control the medical image acquisition apparatus to acquire medical imaging data.

In an embodiment, the first virtual machine accesses a receiving card on the single physical computer by pass-through.

In an embodiment, the second virtual machine accesses a graphics card on the single physical computer by pass-through.

In an embodiment, the third virtual machine accesses a graphics card on the single physical computer by pass-through.

In an embodiment, the fourth virtual machine accesses a control card on the single physical computer by pass-through.

In fact, the method presented in the embodiments of the present invention for displaying medical imaging may be specifically implemented in many ways.

For example, an application programming interface of a certain specification may be observed; the method for displaying medical imaging is written as a plug-in installed in a personal computer or mobile terminal, etc., or can be encapsulated as an application for a user to freely download and use. When written as a plug-in, it can be implemented as many forms of plug-in such as ocx, dll or cab. The method presented in the embodiments of the present invention for displaying medical imaging may also be implemented by specific technologies such as a Flash plug-in, RealPlayer plug-in, MMS plug-in, MIDI staff plug-in or ActiveX plug-in.

The method presented in the embodiments of the present invention for displaying medical imaging may be stored on various storage media by instruction or instruction set storage. These storage media include but are not limited to: floppy disk, optical disk, DVD, hard disk, flash memory, USB stick, CF card, SD card, MMC card, SM card, memory stick, xD card, etc.

In addition, the method presented in the embodiments of the present invention for displaying medical imaging may be applied in storage media based on flash memory (Nand flash), e.g. USB stick, CF card, SD card, SDHC card, MMC card, SM card, memory stick, xD card, etc.

In summary, the medical imaging of the present invention comprises an image display unit and an image reconstruction unit, wherein the image display unit and image reconstruction unit are virtual machines running on a single physical computer; the image reconstruction unit is for receiving medical imaging data, and reconstructing a medical image based on the medical imaging data; the image display unit is for displaying the medical image. As can be seen, when the present invention is adopted, multiple physical computers in a medical imaging apparatus are concentrated in a single physical computer with the aid of virtualization technology, thereby enabling costs to be reduced significantly and the system to be simplified, increasing the system maintenance efficiency.

Furthermore, in the embodiments of the present invention, the virtual machines need not be associated with specific hardware, so that the issue of compatibility in medical apparatus, arising from the fact that certain operating systems are quite old, is also overcome.

Although modifications and changes may be suggested by those skilled in the art, it is the intention of the inventors to embody within the patent warranted hereon all changes and modifications as reasonably and properly come within the scope of their contribution to the art.

We claim as our invention:

1. A medical imaging apparatus, comprises:
an image display unit and an image reconstruction unit, wherein the image display unit and image reconstruction unit are virtual machines running on a single physical computer;
the image reconstruction unit being for receiving medical imaging data, and reconstructing a medical image based on the medical imaging data; and
the image display unit being for displaying the medical image.

2. The medical imaging apparatus as claimed in claim 1, further comprising:
an image post-processing unit which is a virtual machine running on the single physical computer; the image post-processing unit being for acquiring a medical image from the image reconstruction unit, and subjecting the medical image to image post-processing;
and/or further comprising a scan control unit which is a virtual machine running on the single physical computer; the image reconstruction unit being for receiving the medical imaging data from a medical image acquisition apparatus; the scan control unit being for controlling the medical image acquisition apparatus to acquire the medical imaging data.

3. The medical imaging apparatus as claimed in claim 1, wherein:
the image display unit accesses a graphics card on the single physical computer by pass-through;
and/or the image reconstruction unit accesses a receiving card on the single physical computer by pass-through;
and/or the image post-processing unit accesses a graphics card on the single physical computer by pass-through;
and/or the scan control unit accesses a control card on the single physical computer by pass-through.

4. A medical imaging system, comprising:
a medical image acquisition apparatus configured to acquire medical image data;
a medical imaging apparatus configured to receive the medical imaging data from the medical image acquisition apparatus; and
said medical imaging apparatus comprising an image display unit and an image reconstruction unit configured as virtual machines running on a single physical computer, said image reconstruction unit receiving said medical image data and being configured to reconstruct a medical image based on said medical imaging data, and said image display unit being configured to display said medical image.

5. The medical imaging system as claimed in claim 4, wherein the medical image acquisition apparatus is an apparatus selected from the group consisting of a magnetic resonance imaging acquisition apparatus, a computed tomography scanning apparatus, an X-ray imaging acquisition apparatus, an ultrasound imaging acquisition apparatus, a positron emission tomography scanning apparatus, an electroencephalogram acquisition apparatus, a magnetoencephalogram acquisition apparatus, an eye-tracking acquisition apparatus or a transcranial magnetic stimulation acquisition apparatus.

6. A method for displaying medical imaging, comprising:
allocating a first calculation resource and a second calculation resource on a single physical computer;
forming a first virtual machine by virtualization based on the first calculation resource, and forming a second virtual machine by virtualization based on the second calculation resource;
enabling the first virtual machine to receive medical imaging data, and reconstructing a medical image based on the medical imaging data; and
enabling the second virtual machine to display the medical image.

7. The method for displaying medical imaging as claimed in claim 6, comprising:
allocating a third calculation resource on the single physical computer, and forming a third virtual machine by virtualization based on the third calculation resource; the third virtual machine is enabled to acquire a medical image from the first virtual machine, and subject the medical image to image post-processing;
and/or the first virtual machine receives medical imaging data from a medical image acquisition apparatus; further, a fourth calculation resource is allocated on the single physical computer; a fourth virtual machine is formed by virtualization based on the fourth calculation resource; and the fourth virtual machine is enabled to control the medical image acquisition apparatus to acquire medical imaging data.

8. The method for displaying medical imaging as claimed in claim 6, comprising:
from the first virtual machine, accessing a receiving card on the single physical computer by pass-through;
and/or from the second virtual machine, accessing a graphics card on the single physical computer by pass-through;
and/or from the third virtual machine, accessing a graphics card on the single physical computer by pass-through;
and/or from the fourth virtual machine, accessing a control card on the single physical computer by pass-through.
